(19) United States
(12) Patent Application Publication
(10) Pub. No.: US 2014/0072760 A1
(43) Pub. Date: Mar. 13, 2014

(54) Cover Cloth for Outdoor Use

(71) Applicant: PANKO INDUSTRIAL CORPORATION, Taipei (TW)

(72) Inventors: Yung-Yuan Ko, Taipei (TW); Chih-Wen Ko, Taipei (TW)

(73) Assignee: PANKO INDUSTRIAL CORPORATION, Taipei (TW)

(21) Appl. No.: 13/681,530

(22) Filed: Nov. 20, 2012

(30) Foreign Application Priority Data
Sep. 12, 2012 (TW) 101217583

(51) Int. Cl. B32B 3/26; B32B 27/12; B32B 5/02

(52) U.S. Cl. CPC B32B 3/266; B32B 5/022; B32B 27/12
USPC 428/138

(57) ABSTRACT

A cover cloth for outdoor use has the following layers in sequence from outer to inner: a waterproof plastic sheet, a nonwoven outer layer, a waterproof air-permeable membrane and a nonwoven inner layer. The waterproof plastic sheet includes a plurality of ventilation holes. The outermost layer is the waterproof plastic sheet, which is waterproof, air-permeable and sun-resistant so as to protect the inner layers from sun and rain. Thus, the lifespan of the cover cloth is prolonged. In addition, the waterproof plastic sheet has a smooth surface so that dirt adhered to the waterproof plastic sheet can be easily washed away.

This application claims priority to Taiwan patent application Ser. No. 101217583, filed Sep. 12, 2012, as amended Sep. 24, 2012, which is incorporated herein by reference in its entirety.

### BACKGROUND OF THE INVENTION

1. Field of the Invention

The present invention relates to a cover cloth for outdoor use, and more particularly to a cover cloth for outdoor use having the improved characteristics of being waterproof, air-permeable, sun-resistant and washable.

2. Description of the Related Art

A cover cloth for outdoor use is used to cover and protect a vehicle or an outdoor appliance such as a barbecue stove. With reference to FIG. 2, a conventional cover cloth for outdoor use comprises the following layers in sequence from outer to inner: a nonwoven outer layer 50, a waterproof air-permeable membrane 60 and a nonwoven inner layer 70. The nonwoven outer layer 50 is made of a polypropylene spunbond nonwoven fabric. The waterproof air-permeable membrane 60 is made of polyethylene mixed with calcium carbonate. The non-woven inner layer 70 is made of a needle-punched polyester fabric and polypropylene spunbond nonwoven fabric.

The nonwoven outer layer 50, waterproof air-permeable membrane 60 and nonwoven inner layer 70 are all air-permeable so that hot air from the vehicle or outdoor appliance after use and moisture in covering space of the cover cloth can be discharged out. The hot air and moisture will not damage parts and paint of the vehicle or outdoor appliance. Besides, the waterproof air-permeable membrane 60 is waterproof so as to protect parts of the vehicle or outdoor appliance from rusting or being damaged due to rain.

However, the outermost layer is the nonwoven outer layer 50, which is air-permeable but not waterproof. The nonwoven outer layer 50 may get wet in the rain. In addition, dirt may be easily attached to the fibers of the nonwoven outer layer 50 such that a user needs to spend the effort to scrub or brush the cover cloth, and the nonwoven outer layer 50 will fluff after being scrubbed or brushed.

To overcome the shortcomings, the present invention provides a cover cloth for outdoor use to mitigate or obviate the aforementioned problems.

### SUMMARY OF THE INVENTION

The present invention provides a cover cloth for outdoor use having the improved characteristics of being waterproof, breathable, sun-resistant and washable.

A cover cloth for outdoor use in accordance with the present invention comprises the following layers in sequence from outer to inner: a waterproof plastic sheet, a nonwoven outer layer, a waterproof breathable membrane and a nonwoven inner layer. The waterproof plastic sheet includes a plurality of ventilation holes. The outermost layer is the waterproof plastic sheet which is waterproof, breathable and sun-resistant so as to protect the inner layers from sun and rain. Thus, the lifespan of the cover cloth is prolonged. In addition, the waterproof plastic sheet has a smooth surface so that dirt adhered to the waterproof plastic sheet can be easily washed away.

Other objectives, advantages and novel features of the invention will become more apparent from the following detailed description when taken in conjunction with the accompanying drawings.

### BRIEF DESCRIPTION OF THE DRAWINGS

FIG. 1 is an enlarged cross sectional side view of a cover cloth for outdoor use in accordance with the present invention; and

FIG. 2 is an enlarged cross sectional side view of a conventional cover cloth for outdoor use in accordance with the prior art.

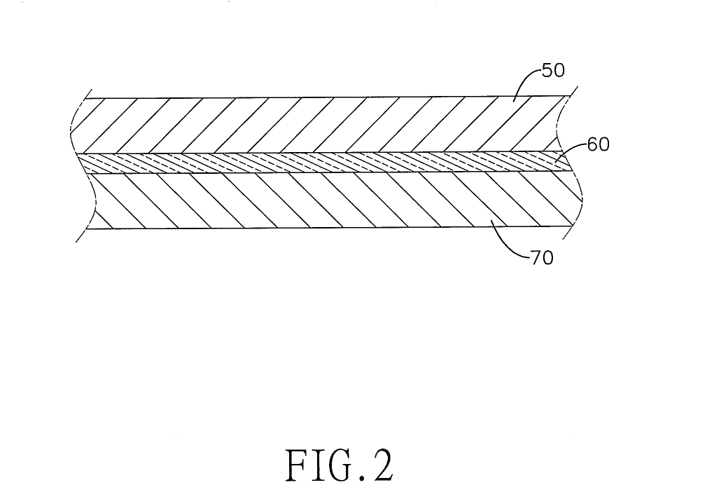

### DETAILED DESCRIPTION OF THE PREFERRED EMBODIMENTS

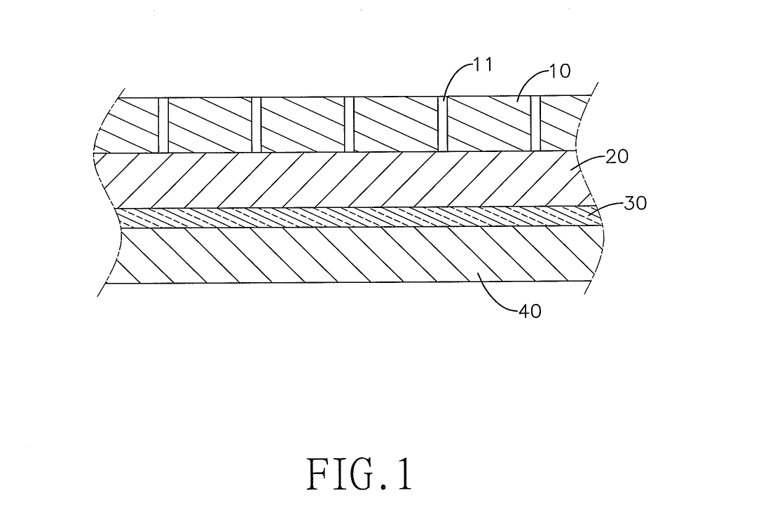

With reference to FIG. 1, a cover cloth for outdoor use in accordance with the present invention comprises the following layers in sequence from outer to inner: a waterproof plastic sheet 10, a nonwoven outer layer 20, a waterproof air-permeable membrane 30 and a nonwoven inner layer 40. The waterproof plastic sheet 10 is waterproof and air-permeable. The waterproof plastic sheet 10 is made of waterproof material such as polyethylene, ethylene vinyl acetate, polyethylene vinyl acetate or polyvinyl chloride. A drilling machine is used to drill a plurality of ventilation holes 11 in the waterproof plastic sheet 10. The nonwoven outer layer 20 is made of a polypropylene spunbond nonwoven fabric. The waterproof air-permeable membrane 30 is made of polyethylene mixed with calcium carbonate. The nonwoven inner layer 40 is made of a needle-punched polyester fabric and polypropylene spunbond nonwoven fabric. The waterproof plastic sheet 10, the nonwoven outer layer 20, the waterproof air-permeable membrane 30 and the nonwoven inner layer 40 are bonded together by an ultrasonic quilting machine. The ultrasonic quilting machine forms a plurality of fusing points on the cover cloth. The layers are only fused together at the fusing points. The layers can still be air-permeable at the non-fused region.

The outermost layer is the waterproof plastic sheet 10, which is waterproof, air-permeable and sun-resistant so as to protect the inner layers from sun and rain. Thus, the lifespan of the cover cloth is prolonged. In addition, the waterproof plastic sheet 10 has a smooth washable surface so that dirt is not easily adhered to the waterproof plastic sheet 10. The cover cloth can be easily washed and the waterproof plastic sheet 10 does not fluff after being washed.

Even though numerous characteristics and advantages of the present invention have been set forth in the foregoing description, together with details of the structure and features of the invention, the disclosure is illustrative only. Changes may be made in the details, especially in matters of shape, size and arrangement of parts within the principles of the invention to the full extent indicated by the broad general meaning of the terms in which the appended claims are expressed.

What is claimed is:

1. A cover cloth for outdoor use comprising following layers in sequence from outer to inner:
a waterproof plastic sheet including a plurality of ventilation holes;
a nonwoven outer layer;
a waterproof air-permeable membrane; and
a nonwoven inner layer.

2. The cover cloth for outdoor use as claimed in claim 1, wherein the waterproof plastic sheet, the nonwoven outer layer, the waterproof air-permeable membrane and the nonwoven inner layer are bonded together.

3. The cover cloth for outdoor use as claimed in claim 1, wherein the waterproof plastic sheet is made of polyethylene, ethylene vinyl acetate, polyethylene vinyl acetate or polyvinyl chloride.

4. The cover cloth for outdoor use as claimed in claim 2, wherein the waterproof plastic sheet is made of polyethylene, ethylene vinyl acetate, polyethylene vinyl acetate or polyvinyl chloride.

5. The cover cloth for outdoor use as claimed in claim 3, wherein the nonwoven outer layer is made of a polypropylene spunbond nonwoven fabric.

6. The cover cloth for outdoor use as claimed in claim 4, wherein the nonwoven outer layer is made of a polypropylene spunbond nonwoven fabric.

7. The cover cloth for outdoor use as claimed in claim 5, wherein the waterproof air-permeable membrane is made of polyethylene mixed with calcium carbonate.

8. The cover cloth for outdoor use as claimed in claim 6, wherein the waterproof air-permeable membrane is made of polyethylene mixed with calcium carbonate.

9. The cover cloth for outdoor use as claimed in claim 7, wherein the nonwoven inner layer is made of a needle-punched polyester fabric and polypropylene spunbond nonwoven fabric.

10. The cover cloth for outdoor use as claimed in claim 8, wherein the nonwoven inner layer is made of a needle-punched polyester fabric and polypropylene spunbond nonwoven fabric.
